(19) United States
(12) Patent Application Publication
(10) Pub. No.: US 2017/0175679 A1
(43) Pub. Date: Jun. 22, 2017

(54) HYDRAULIC PUMP SYSTEMS

(71) Applicant: Hamilton Sundstrand Corporation, Charlotte, NC (US)

(72) Inventor: Richard A. Himmelmann, Beloit, WI (US)

(21) Appl. No.: 14/972,902

(22) Filed: Dec. 17, 2015

(51) Int. Cl. F02K 9/84; F04D 1/00; F04D 15/00; F04D 13/04

(52) U.S. Cl. CPC F02K 9/84; F04D 13/04; F04D 1/00; F04D 15/0066

(57) ABSTRACT

A pump system includes a turbine shaft including a turbine disposed thereon to rotate the turbine shaft at a turbine shaft speed due to fluid flow through the turbine, a centrifugal pump directly connected to the turbine shaft and configured to pump hydraulic fluid at the turbine shaft speed, a bleed port disposed downstream of the centrifugal pump, and a valve configured to be fluidly connected to the bleed port and configured to meter flow to the turbine to regulate the turbine shaft speed at least partially as a function of pressure from the bleed port.

### BACKGROUND

1. Field

The present disclosure relates to pump systems, more specifically to hydraulic pump systems (e.g., for rockets).

2. Description of Related Art

For nearly 80 years, engineers and scientists have been using rockets to launch payloads into orbit around the earth. These rockets are maneuvered by vectoring the rocket engine thrust direction. The thrust vector control (TVC) system for many of today's rockets relies on hydraulic rams to displace the engine nozzle angle, relative to the rocket core axis. These hydraulic rams require high pressure hydraulic fluid pumping systems capable of providing up to 4000 psia at flow rates of more than 100 gpm, for example.

This hydraulic flow and pressure is typically generated by a Turbine Pump Assembly (TPA). Traditional TPAs can be powered by hot combustion products or high pressure cold gas provided by the main engine turbo-pump assembly. Typically the TPA turbine operates most efficiently at very high rpm (e.g., 115,000 rpm in certain TPAs). This is in contrast to the hydraulic pump which needs to operate at much lower speeds (e.g., about 6100 rpm in certain cases) and is relatively expensive. Also, the turbine rotational speed is controlled by a turbine speed control valve (e.g., with a flyweight governor actuated spool valve), which also operates at a lower RPM to control flow to the turbine.

To accommodate the differences in operating speed between the turbine and the hydraulic pump/turbine speed control valve, a gear reduction system is incorporated between the hydraulic pump/valve and the turbine. The gear reduction systems of traditional systems must be geared properly and must be robust enough to transfer power to both the hydraulic pump and valve mechanically linked thereto. Accordingly, traditional systems are large, complex, expensive, and require high part count.

Such conventional methods and systems have generally been considered satisfactory for their intended purpose. However, there is still a need in the art for improved pump systems. The present disclosure provides a solution for this need.

### SUMMARY

A pump system includes a turbine shaft including a turbine disposed thereon to rotate the turbine shaft at a turbine shaft speed due to fluid flow through the turbine, a centrifugal pump directly connected to the turbine shaft and configured to pump hydraulic fluid at the turbine shaft speed, a bleed port disposed downstream of the centrifugal pump, and a valve configured to be fluidly connected to the bleed port and configured to meter flow to the turbine to regulate the turbine shaft speed at least partially as a function of pressure from the bleed port.

The valve can include a valve piston disposed therein and configured to move a valve shaft at least partially toward a closed position at a closure pressure from the bleed port. The centrifugal pump can be disposed at an opposite end of the turbine shaft relative to the turbine.

The pump system can further include a speed reduction system operatively connected to the turbine shaft and configured to have an output speed less than the turbine shaft speed. The valve can be operatively connected to the speed reduction system and configured to operate at the output speed such that the valve can meter flow to the turbine to regulate the turbine shaft speed at least partially as a function of the output speed of the speed reduction system.

The speed reduction system can include a turbine shaft gear operatively disposed on the turbine shaft. In certain embodiments, the speed reduction system can include a valve gear operatively disposed around a valve shaft of the valve to rotate the valve shaft at the output speed. The valve gear can house a flyweight governor of the valve disposed around the valve shaft.

The speed reduction system can include a first stage gear meshed with the turbine shaft gear. The speed reduction system can include a second stage gear connected to the first stage gear and configured to rotate at a first stage gear speed. The second stage gear can be meshed with the valve gear to rotate the valve gear.

The turbine can be configured to operate with cold rocket fuel or any other suitable fluid. For example, the turbine can be configured to operate with hot gas.

In accordance with at least one aspect of this disclosure, a hydraulic steering system for a rocket nozzle can include a hydraulic mechanism configured to modify a thrust vector of a nozzle and a pump system as described above.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1A is a perspective view of an embodiment of a pump system in accordance with this disclosure;

FIG. 1B is a partial cutaway view of the system of FIG. 1A, showing an embodiment of a speed reduction system in accordance with this disclosure;

FIG. 1C is a partial cutaway view of the system of FIG. 1A from a different angle;

FIG. 1D is a cross-sectional elevation view of the system of FIG. 1A, showing a cross-section through the turbine shaft and the valve shaft;

FIG. 1E is a cross-sectional perspective view of the system of FIG. 1A, showing a cross-section through the turbine shaft and the second gear of the speed reduction system;

FIG. 1F is a cross-sectional perspective view of the system of FIG. 1A, showing a cross-section through the second gear of the speed reduction system and the valve shaft;

FIG. 2A is a perspective view of an embodiment of a pump system in accordance with this disclosure;

FIG. 2B is a phantom perspective view of the system of FIG. 2A, showing an embodiment of a valve shown in accordance with this disclosure;

FIG. 2C is a cross-sectional elevation view of the system of FIG. 2A, showing a cross-section through the turbine shaft and the valve shaft;

FIG. 2D is a cross-sectional perspective view of an embodiment of the valve of the system of FIG. 2A, shown operatively connected to a bleed port of a pump in accordance with this disclosure;

FIG. 2E is a side elevation view of the system of FIG. 2A;

FIG. 3A is a perspective view of an embodiment of a pump system in accordance with this disclosure, shown including a combination valve in accordance with this disclosure;

FIG. 3B is a cross-sectional elevation view of the system of FIG. 3A, showing a cross-section through the valve shaft and a second stage gear;

FIG. 3C is a cross-sectional elevation view of the system of FIG. 3A, showing a cross-section through the valve shaft and the turbine shaft;

FIG. 4 is side by side comparison of the system of FIG. 2A and a traditional system; and

FIG. 5 is a partial perspective view of a hydraulic steering system for a rocket nozzle.

### DETAILED DESCRIPTION

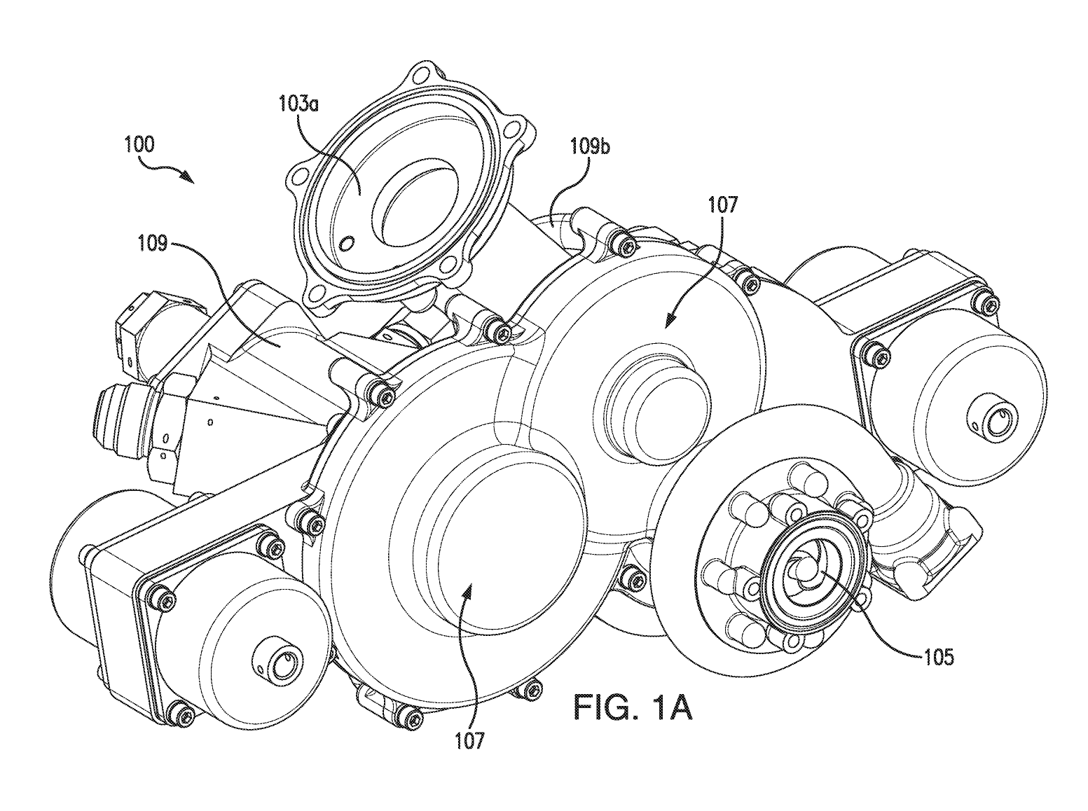

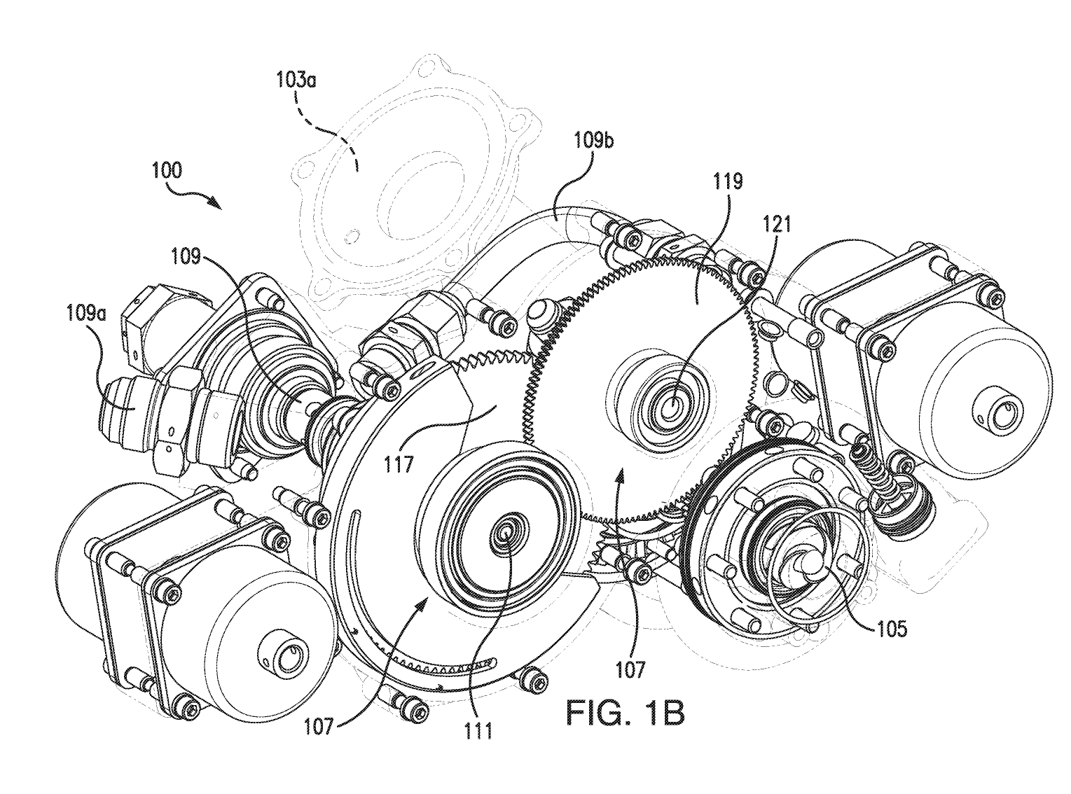

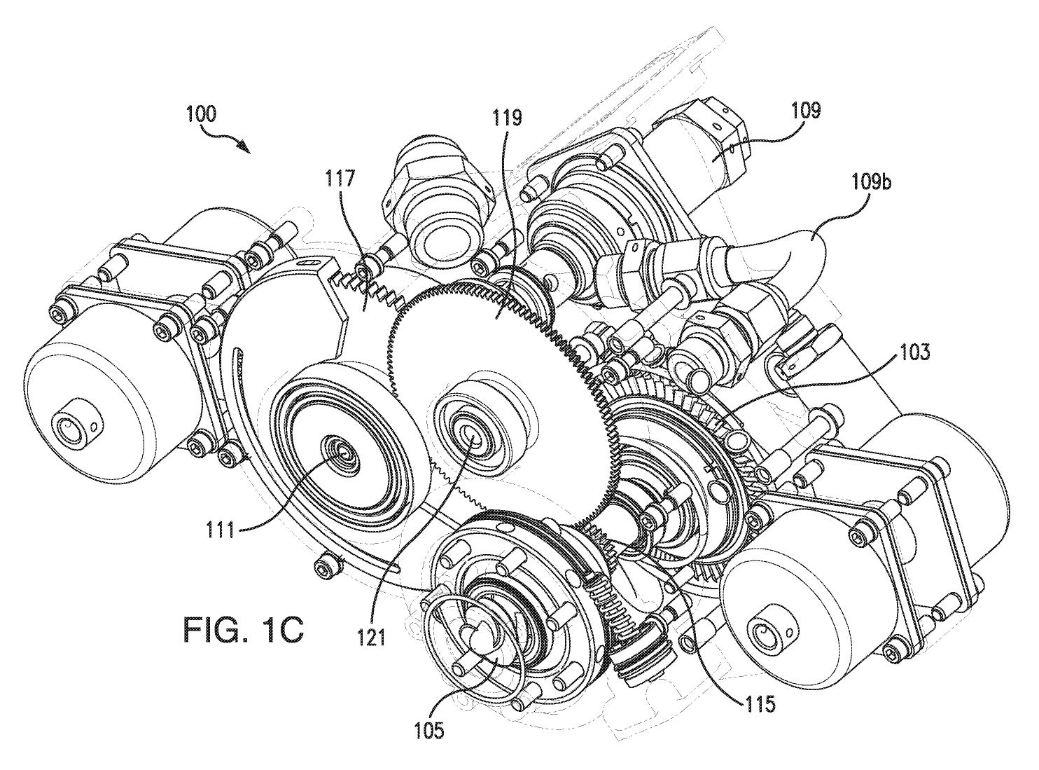

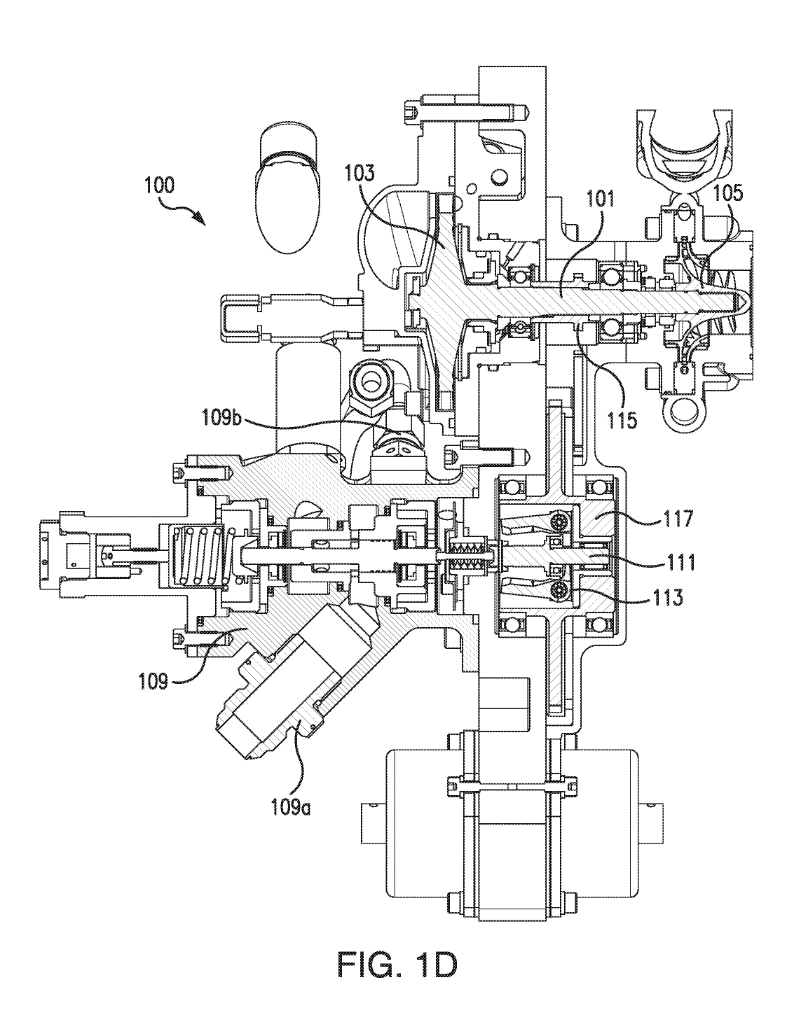

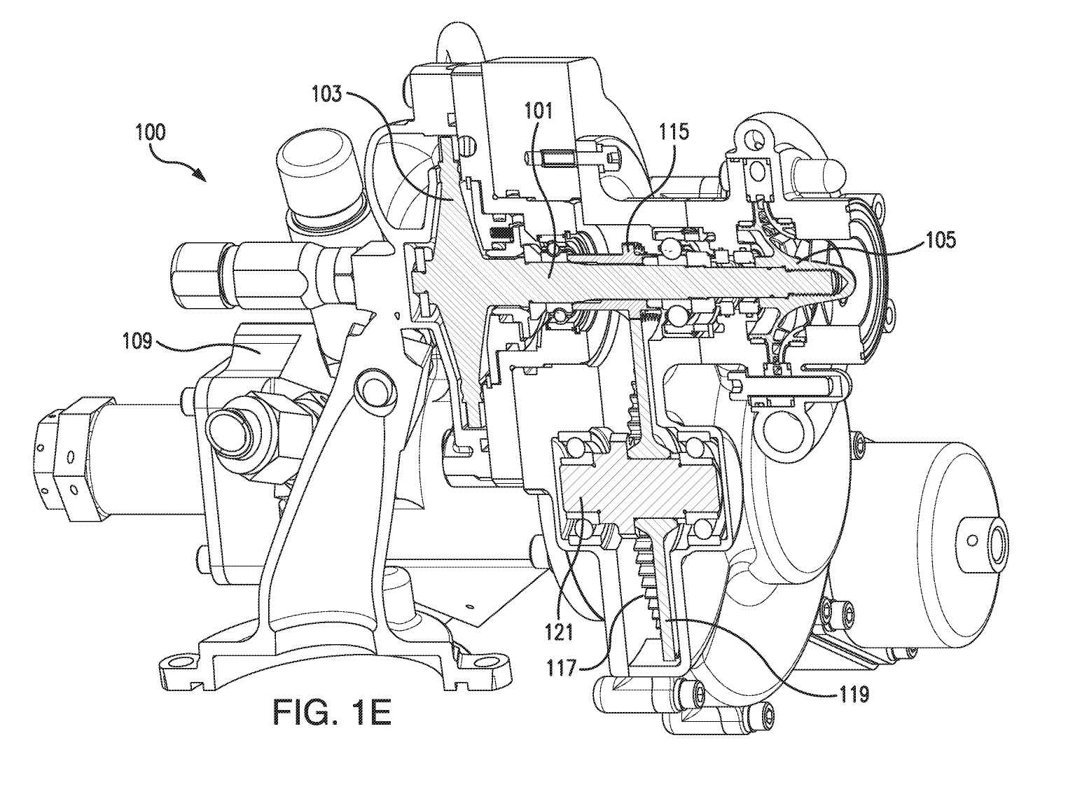

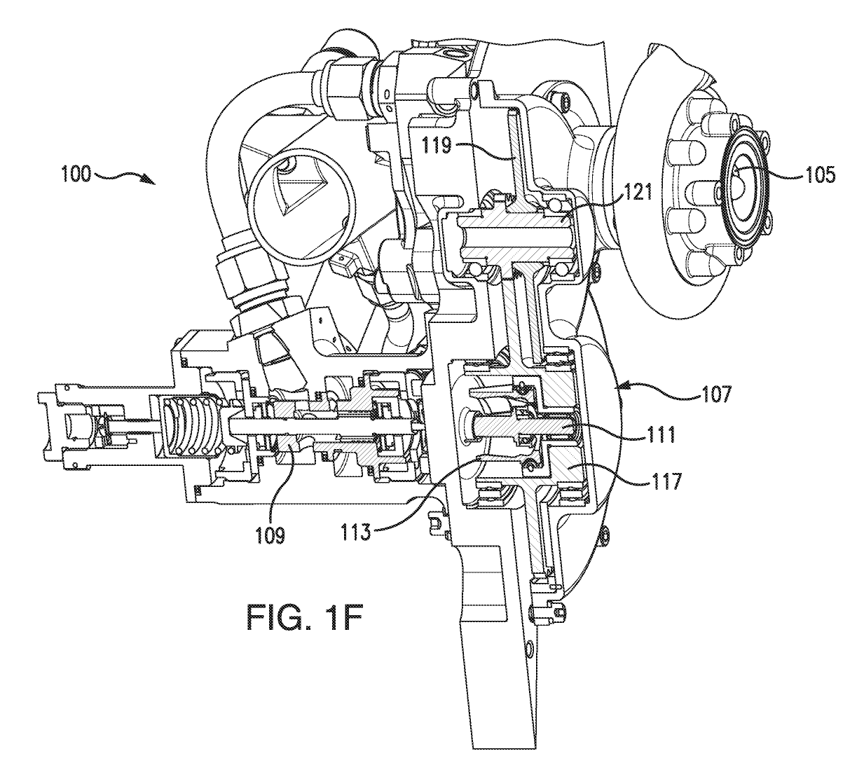

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1A and is designated generally by reference character 100.

Other embodiments and/or aspects of this disclosure are shown in FIGS. 1B-5. The systems and methods described herein can be used to reduce the size, weight, and cost of pumping systems (e.g., for rockets).

Referring to FIGS. 1A-1F, a pump system 100 includes a turbine shaft 101 including a turbine 103 disposed thereon to rotate the turbine shaft 101 at a turbine shaft speed due to fluid flow through the turbine 103. The turbine 103 can be configured to operate with cold (e.g., gaseous) rocket fuel. In certain embodiments, the turbine 103 can be configured to operate with hot gas (e.g., exhaust). It is contemplated that the turbine 103 can be configured to operate with any other suitable fluid.

The system 100 further includes a centrifugal pump 105 directly connected to the turbine shaft 101 and configured to pump hydraulic fluid at the turbine shaft speed. As shown, the centrifugal pump 105 can be disposed at an opposite end of the turbine shaft 101 relative to the turbine 103, however, any other suitable location is contemplated herein. The centrifugal pump 105 is configured to be in fluid communication with a hydraulic fluid source and a suitable hydraulic mechanism (e.g., for steering a rocket nozzle).

The pump system 100 also includes a speed reduction system 107 operatively connected to the turbine shaft 101. The speed reduction system 107 is configured to have an output speed less than the turbine shaft speed.

A valve 109 is operatively connected to the speed reduction system 107 that is configured to operate at the slower speed output by the speed reduction system 107. The valve 109 is configured to meter flow to the turbine 103 to regulate the turbine shaft speed. The valve 109 includes and inlet portion 109a configured to be in fluid communication with a pressurized fluid source and an outlet portion 109b in fluid communication with the turbine 103. The valve 109 selectively allows flow from the inlet 109a to the outlet 109b to pass through the turbine 103, thereby rotating the turbine 103 and passing through a turbine outlet 103a.

The valve 109 can be any suitable components and/or design, as appreciated by those having ordinary skill in the art. For example, as shown, the valve 109 is a flyweight governor type valve including a valve shaft 111 and a flyweight assembly 113 that is configured to move the valve 109 toward a closed position when rotated above a predetermined speed in order to keep the turbine shaft 101 spinning at or below a desired speed.

As shown, the speed reduction system 107 can include a turbine shaft gear 115 operatively disposed on the turbine shaft 101. The speed reduction system 107 can also include a valve gear 117 operatively disposed around the valve shaft 111 of the valve 109 to rotate the valve shaft 111 at the output speed. As shown, the valve gear 117 can house a flyweight governor assembly 113 of the valve 109 that is disposed around the valve shaft 111. In certain embodiments, the speed reduction system 107 can include a first stage gear 119 meshed with the turbine shaft gear 115. The speed reduction system 107 can include a second stage gear 121 connected to the first stage gear 119 and configured to rotate at a first stage gear speed with the first stage gear 119. The second stage gear 121 can be meshed with the valve gear 117 to rotate the valve gear 117. This relationship creates a two stage speed reduction from the turbine shaft 101 to the valve shaft 111.

As described above, certain embodiments as described above do not need speed reduction to the pump assembly because a centrifugal pump 105 is utilized in direct mechanical relationship with the turbine shaft 101. In this regard, the faster the turbine shaft 101 is allowed to spin, the smaller the centrifugal pump 105 needs to be. Also, since the pump requires power transfer and the valve does not require much at all, traditional systems had to utilize large, robust gear systems with many more components. In embodiments as described herein, no significant power has to be transferred through the speed reduction system 107 which allows a significant reduction in the size, weight, complexity, and cost of such pump systems (e.g., that can be used for hydraulic pumping on for rocket nozzle steering).

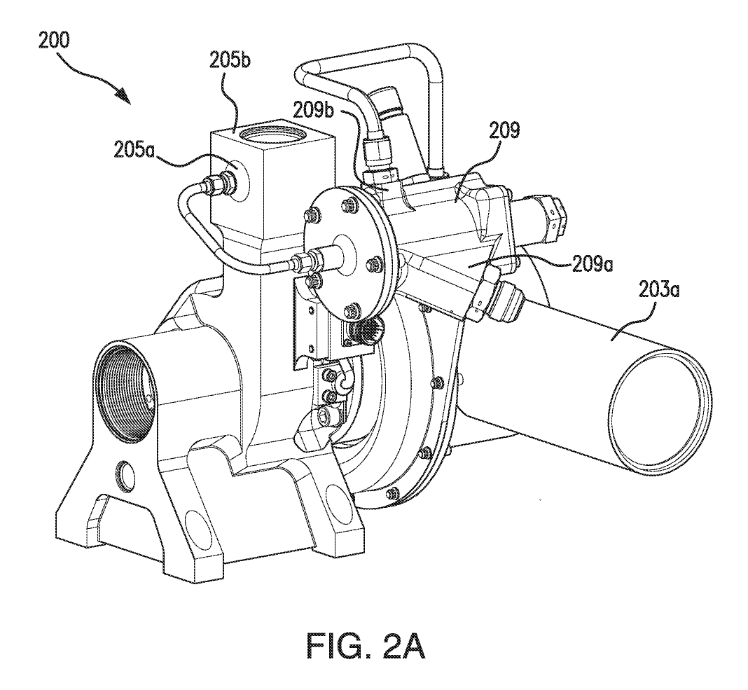

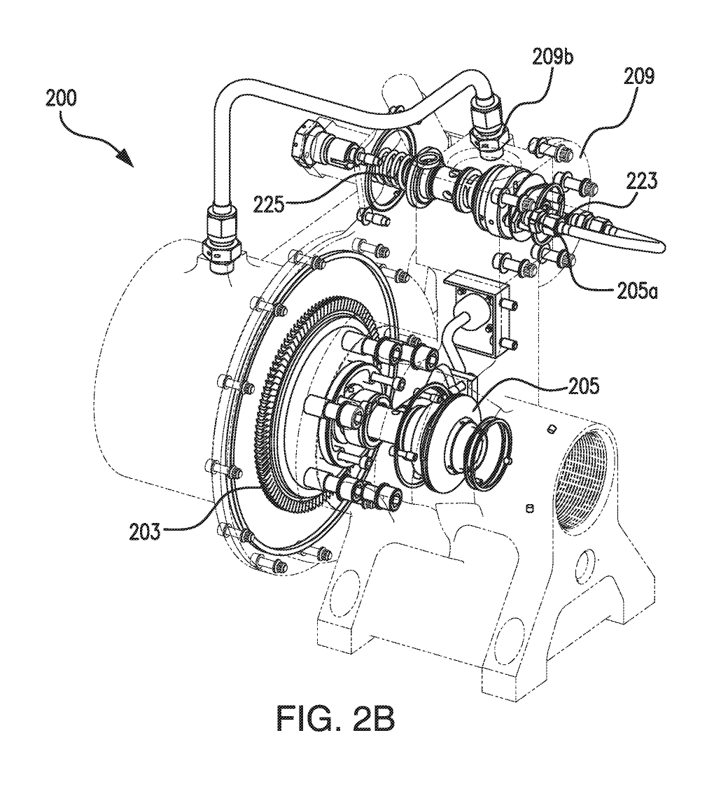

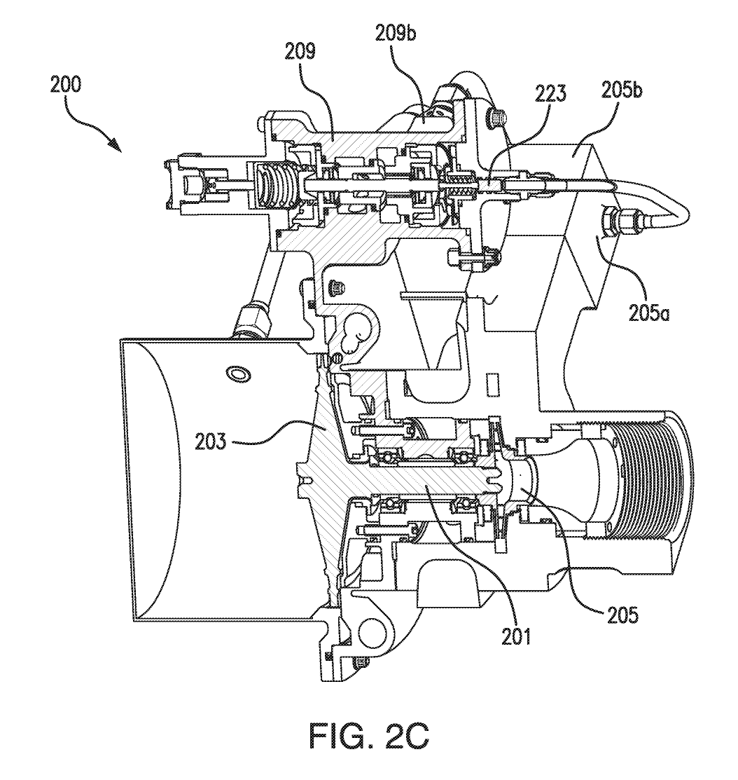

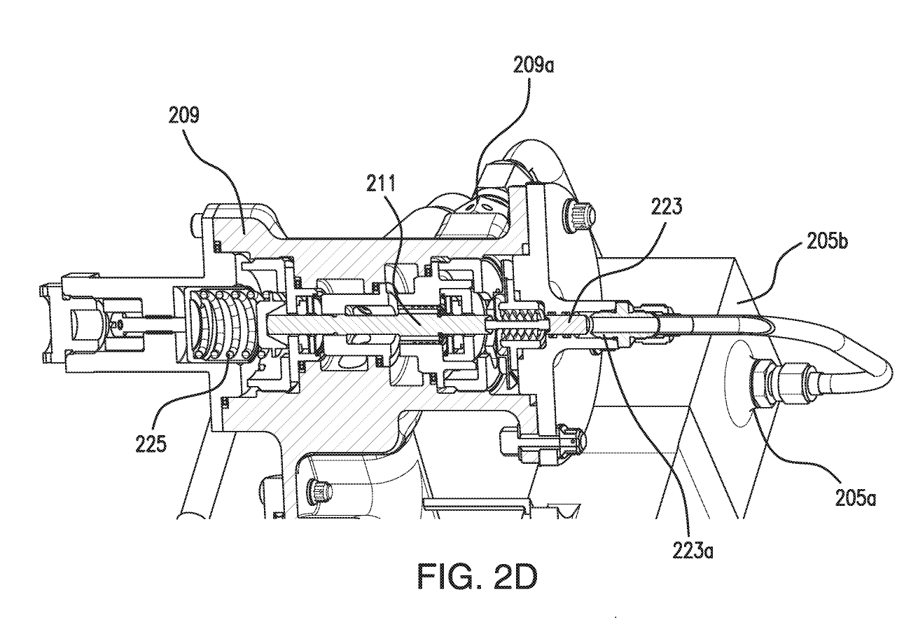

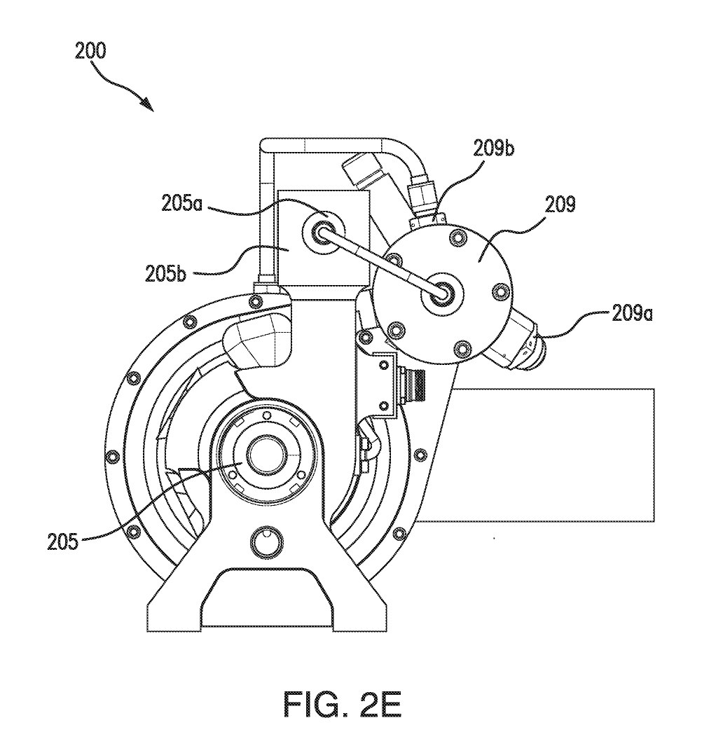

Referring to FIGS. 2A-2E, an embodiment of a pump system 200 can include certain similar features and/or operate similarly as system 100 as described above, having a pressure actuated valve 209 and no speed reduction system. For example, the system 200 can include a turbine shaft 201 including a turbine 203 disposed thereon to rotate the turbine shaft 201 at a turbine shaft speed due to fluid flow through the turbine 203, similar to the above described components of system 100.

Similar to the system 100 as described above, the system 200 also includes a centrifugal pump 205 directly connected to the turbine shaft 201 and configured to pump hydraulic fluid at the turbine shaft speed. As shown, the centrifugal pump 205 can be disposed at an opposite end of the turbine shaft 201 relative to the turbine 203.

The system 200 further includes a bleed port 205a disposed downstream of the centrifugal pump 205 (e.g., in pump outlet 205b as shown). The valve 209 is configured to be fluidly connected to the bleed port 205a and is configured to meter flow to the turbine 203 (from inlet portion 209a to outlet portion 209b, similar to valve 109 as described above) to regulate the turbine shaft speed at least partially as a function of pressure from the bleed port 205a.

The valve 209 can include a valve piston 223 disposed therein (e.g., in a piston cavity 223a defined by the valve 209) and configured to move a valve shaft 211 of the valve 209 at least partially toward a closed position at a predetermined closure pressure from the bleed port 205a. As shown, the valve 209 can include a biasing member 225 (e.g., a spring) configured to provide a biasing force to the valve shaft 211 toward the open position (e.g., similar to the embodiment as shown in FIG. 1A). Any other suitable components for the valve 209 are contemplated herein.

In this regard, as shown, the more pressure that is produced by the centrifugal pump 205, the more the valve piston 223 forces the valve shaft 211 toward the closed position, against the biasing force of the biasing member 225, to ultimately regulate the speed of the turbine 203 and centrifugal pump 205 without the need for a geared connection to the turbine shaft 201. This can allow the valve 209 to be simplified and an overall reduction of weight due to a reduction in components of system 200 (e.g., removal of speed reduction gears, flyweights, etc.) in comparison to traditional systems.

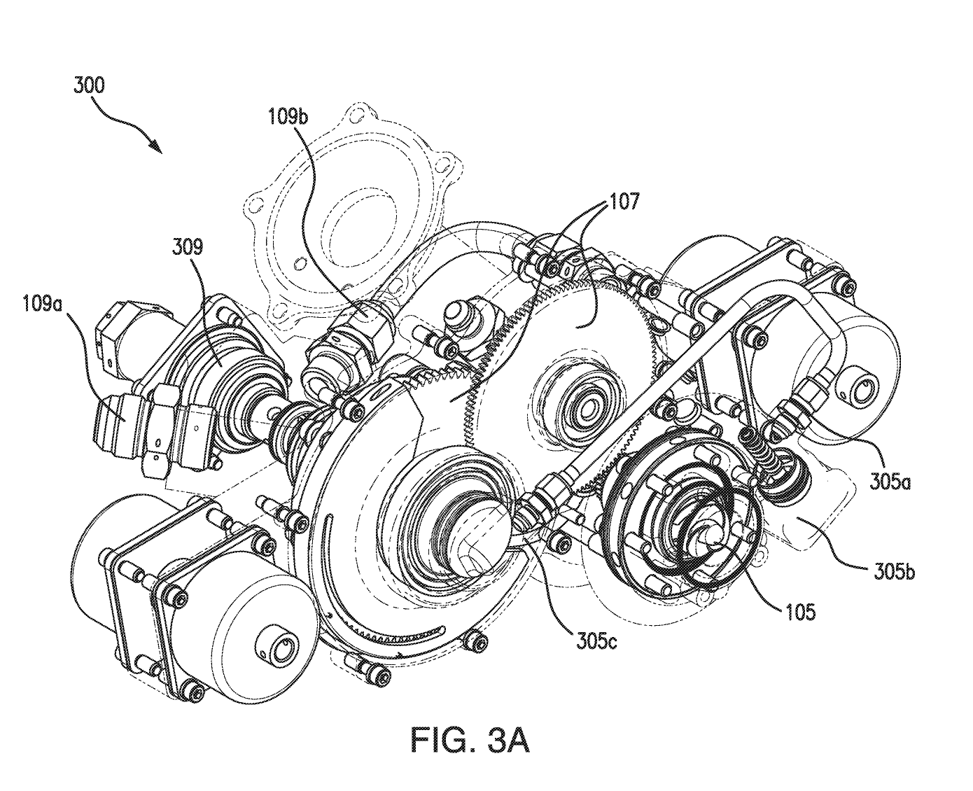

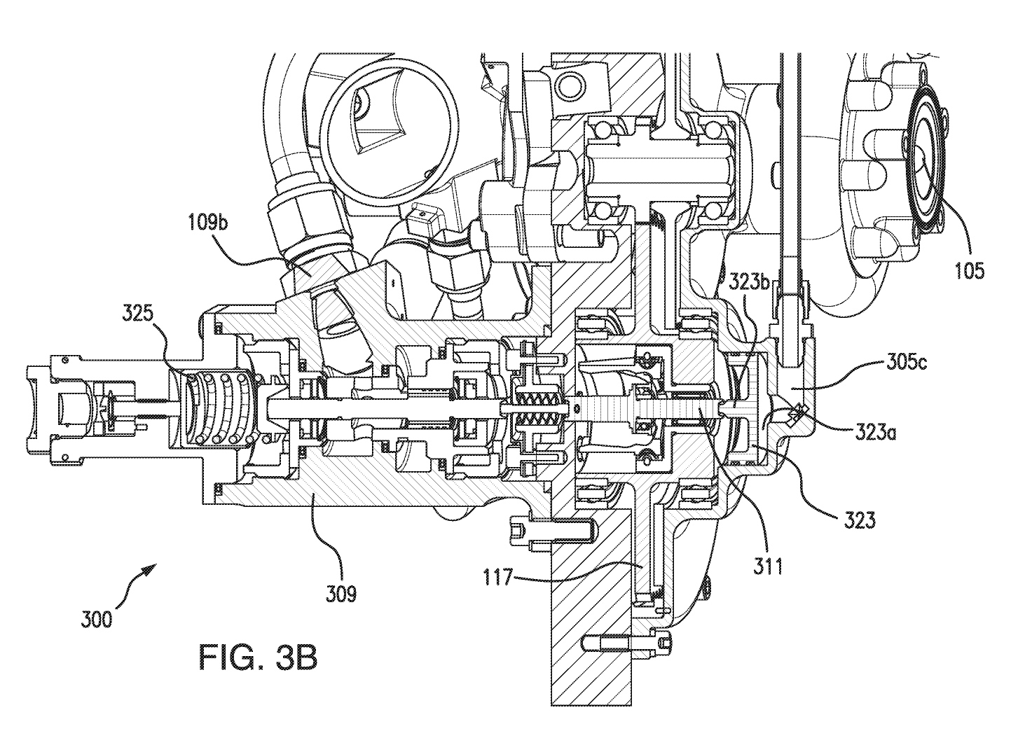

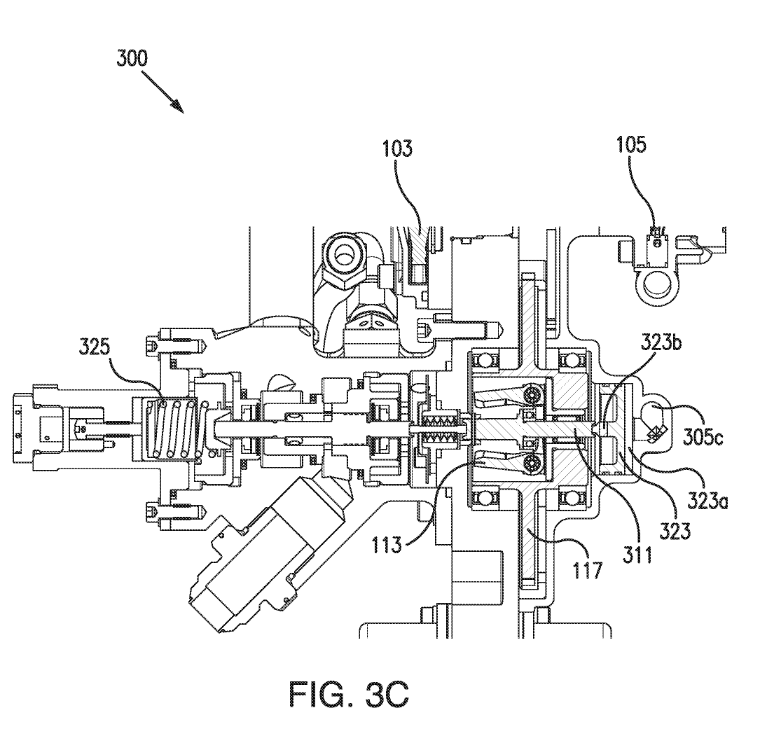

While the embodiment of FIGS. 2A-2E shows a pressure actuated valve 209 configured to operate without rotation, it is contemplated that pressure actuation can be implemented in any suitable manner, including in embodiments of valves that operate with rotation (e.g., as in valve 109 of system 100). For example, referring to FIGS. 3A-3C, a system 300 includes similar components (e.g., turbine shaft 101, turbine 103, centrifugal pump 105, speed reduction system 107) with a valve 309 similar to valve 109 and having the addition of pressure actuation.

As shown, the valve 309 can be operatively connected to the speed reduction system 107 to operate at the slower speed output by the speed reduction system 107, similar to valve 109, and can include similar features to those of valve 109 as described above (e.g. inlet portion 109a, outlet portion 109b, a flyweight governor assembly 103 disposed around valve shaft 311).

The system 300 further includes a bleed port 305a disposed downstream of the centrifugal pump 105 (e.g., in pump outlet 305b as shown). The valve 309 is configured to be fluidly connected to the bleed port 305a and is configured to meter flow to the turbine 103 (from inlet portion 109a to outlet portion 109b, similar to valve 109 as described above) to regulate the turbine shaft speed at least partially as a function of pressure from the bleed port 305a.

The valve 309 can include a valve piston 323 disposed therein. The valve piston 323 can be disposed in a piston cavity 323a defined by any suitable portion of system 300 (e.g., valve 309 and/or a cover 305c of speed reduction system 107 as shown). The valve piston 323 is configured to move a valve shaft 311 of the valve 309 at least partially toward a closed position at a predetermined closure pressure from the bleed port 305a.

In the embodiment shown, valve shaft 311 and valve piston 323 can move in the axial direction and do not rotate. As shown, the valve gear 117 rotates about the valve shaft 311 on at least one bearing that support the valve shaft 311 (which doesn't rotate) within the rotating valve gear 117. In certain embodiments, however, the valve shaft can rotate relative to the valve piston 323. The valve piston 323 can also include a pintle portion 323b configured to register the valve piston 323 with the valve shaft 311 in a slidable abutment about the axis of the valve shaft 311 such that the valve shaft 311 can rotate without rotating the valve piston 323. The pintle portion 323b can reduce in size to reduce friction from the rotation of the valve shaft 311 relative to the pintle portion 323b.

As shown, the valve 309 can include a biasing member 325 (e.g., a spring) configured to provide a biasing force to the valve shaft 311 toward the open position (e.g., similar to the embodiment as shown in FIG. 1A). Any other suitable components for the valve 309 are contemplated herein.

As shown in FIGS. 3A-3C, the more pressure that is produced by the centrifugal pump 105, the more the valve piston 323 forces the valve shaft 311 toward the closed position, against the biasing force of the biasing member 325, to ultimately regulate the speed of the turbine 303 and centrifugal pump 305. However, rotation from the turbine shaft 101 through the speed reduction system 107 can also be used in conjunction with or alternative to the pressure actuation to actuate the valve 309, as described above with respect to valve 109 (e.g., using the flyweight governor assembly 113 to actuate valve shaft 311).

Any suitable distribution of effect between the rotational component of actuation and the pressure component of actuation is contemplated herein. For example, the valve 309 can be configured to operate mostly based on pressure from the bleed port 305a which can allow for reduction of the size and/or weight of the flyweight governor assembly 113 required to fully operate the valve 309. Alternatively, it is contemplated that either the rotational component or the pressure component can be independently capable of fully operating the valve 309 independently of the other component. The valve 309 can allow redundant systems for safety and/or allow for an overall reduction of weight due to a reduction in size and/or complexity of certain components (e.g., flyweight governor assembly) in comparison to traditional systems.

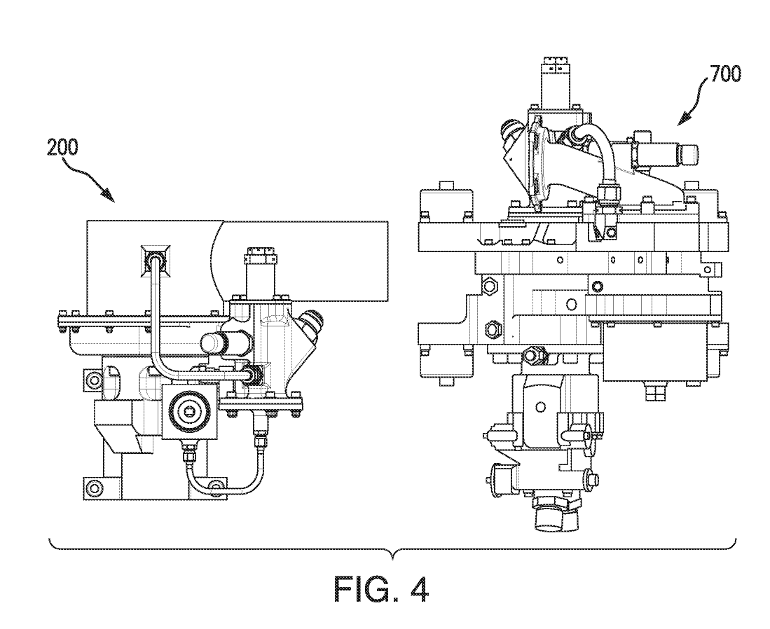

As an example of size reduction of certain embodiments in accordance with this disclosure, referring to FIG. 4, the pump system 200 is shown next to a traditional pump 700 having a geared pump assembly with similar pumping output. It can clearly be seen that there is a significant reduction in size and weight which is beneficial for rocket systems as it increases available payload.

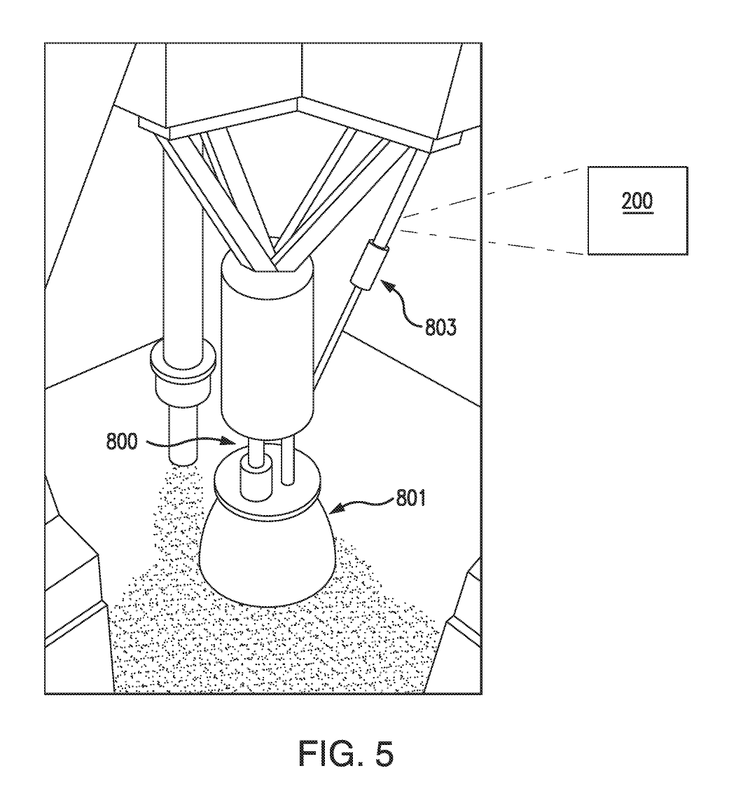

Referring to FIG. 5, a hydraulic steering system 800 for a rocket nozzle 801 can include a hydraulic mechanism 803 configured to modify a thrust vector of the nozzle 801 and an embodiment of a pump system (e.g., pump systems 200, 300) as described above operatively connected to the hydraulic mechanism 803 to supply the hydraulic mechanism 803 with hydraulic fluid.

The methods and systems of the present disclosure, as described above and shown in the drawings, provide for pump systems with superior properties including reduced size, weight, complexity, and/or cost. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A pump system, comprising:
a turbine shaft including a turbine disposed thereon to rotate the turbine shaft at a turbine shaft speed due to fluid flow through the turbine;
a centrifugal pump directly connected to the turbine shaft and configured to pump hydraulic fluid at the turbine shaft speed;
a bleed port disposed downstream of the centrifugal pump; and
a valve configured to be fluidly connected to the bleed port and configured to meter flow to the turbine to regulate the turbine shaft speed at least partially as a function of pressure from the bleed port.

2. The pump system of claim 1, wherein the valve includes a valve piston disposed therein and configured to move a valve shaft at least partially toward a closed position at a closure pressure from the bleed port.

3. The pump system of claim 1, further comprising a speed reduction system operatively connected to the turbine shaft and configured to have an output speed less than the turbine shaft speed, wherein the valve is operatively connected to the speed reduction system and configured to operate at the output speed, wherein the valve is configured to meter flow to the turbine to regulate the turbine shaft speed at least partially as a function of the output speed.

4. The pump system of claim 3, wherein the speed reduction system includes a turbine shaft gear operatively disposed on the turbine shaft.

5. The pump system of claim 4, wherein the speed reduction system includes a valve gear operatively disposed around a valve shaft of the valve to rotate the valve shaft at the output speed.

6. The pump system of claim 5, wherein the speed reduction system further includes a first stage gear meshed with the turbine shaft gear.

7. The pump system of claim 6, wherein the speed reduction system further includes a second stage gear connected to the first stage gear and configured to rotate at a first stage gear speed, wherein the second stage gear is meshed with the valve gear to rotate the valve gear.

8. The pump of claim 1, wherein the turbine is configured to operate with cold rocket fuel.

9. The pump of claim 1, wherein the turbine is configured to operate with hot gas.

10. The pump of claim 1, wherein the centrifugal pump is disposed at an opposite end of the turbine shaft relative to the turbine.

11. The pump of claim 3, wherein the valve gear houses a flyweight governor of the valve disposed around the valve shaft.

12. A hydraulic steering system for a rocket nozzle, comprising:
a hydraulic mechanism configured to modify a thrust vector of a nozzle; and
a pump system, comprising:
a turbine shaft including a turbine disposed thereon to rotate the turbine shaft at a turbine shaft speed due to fluid flow through the turbine;
a centrifugal pump directly connected to the turbine shaft and configured to pump hydraulic fluid at the turbine shaft speed;
a bleed port disposed downstream of the centrifugal pump; and
a valve configured to be fluidly connected to the bleed port and configured to meter flow to the turbine to regulate the turbine shaft speed at least partially as a function of pressure from the bleed port.

13. The pump system of claim 12, wherein the valve includes a valve piston disposed therein and configured to move a valve shaft at least partially toward a closed position at a closure pressure from the bleed port.

14. The pump system of claim 12, further comprising a speed reduction system operatively connected to the turbine shaft and configured to have an output speed less than the turbine shaft speed, wherein the valve is operatively connected to the speed reduction system and configured to operate at the output speed, wherein the valve is configured to meter flow to the turbine to regulate the turbine shaft speed at least partially as a function of the output speed.

15. The system of claim 14, wherein the speed reduction system includes a turbine shaft gear operatively disposed on the turbine shaft.

16. The system of claim 15, wherein the speed reduction system includes a valve gear operatively disposed around a valve shaft of the valve to rotate the valve shaft at the output speed.

17. The system of claim 16, wherein the speed reduction system further includes a first stage gear meshed with the turbine shaft gear.

18. The system of claim 14, wherein the speed reduction system further includes a second stage gear connected to the first stage gear and configured to rotate at a first stage gear speed, wherein the second stage gear is meshed with the valve gear to rotate the valve gear.
